(19) United States
(12) Patent Application Publication
(10) Pub. No.: US 2019/0170391 A1
(43) Pub. Date: Jun. 6, 2019

(54) A LOUVRE ASSEMBLY

(71) Applicant: Hodgson Sayers Limited, Durham (GB)

(72) Inventor: Robert Edmund TODD, Northumberland (GB)

(73) Assignee: Hodgson Sayers Limited, Durham (GB)

(21) Appl. No.: 16/307,610

(22) PCT Filed: Jun. 5, 2017
(86) PCT No.: PCT/GB2017/051607

§ 371 Date: Dec. 6, 2018

(30) Foreign Application Priority Data
Jun. 6, 2016 (GB) 1609831.1

(51) Int. Cl. F24F 13/18; E06B 7/08; F24F 13/15; F24F 13/24

(52) U.S. Cl. CPC F24F 13/18; F24F 13/24; F24F 13/15; E06B 7/08

(57) ABSTRACT

A louvre assembly is described for fitment to doors and/or housing structures for the purposes of allowing air spaces either side of doors and/or internally and externally of such housing structures to intermix. The louvre assembly includes a louvre housing having a continuous louvre housing perimeter wall; a louvre housing cavity surroundingly defined and formed by the louvre housing perimeter wall so as to have first and second laterally spaced open faces; and a louvre formation comprising a plural array of louvre slats removably mountable within the louvre housing cavity. The louvre assembly additionally or alternatively further includes a baffle formation removably mountable over said first open face and comprising: an apertured first closure plate associatively engageable with the louvre housing to seat over said first open face; an unapertured baffle box back plate; a baffle box perimeter formation extending between and laterally spacing apart the first closure plate and the baffle box back plate and forming thereby a baffle cavity; the baffle box perimeter formation having at least one apertured portion communicating with the said baffle cavity. Doors and/or housing structures incorporating such louvre assemblies are also described.

The present invention relates to doors and/or housing structures, and in particular to louvres and louvre assemblies for the purposes of allowing air spaces either side of such doors and/or internally and externally of such housing structures to intermix. The present invention relates in particular to secured housing structures and/or security doors and in particular to louvres and louvre assemblies for secured housing structures and/or security doors. The present invention further relates to doors and/or housing structures incorporating such louvre assemblies.

### INTRODUCTION

Estate security is expensive to implement and maintain across a large regional or national geographic area, often because the dynamics of the threat can be locally influenced.

Threats are dynamic, thus frequently making existing security systems redundant before the capital expenditure has been amortized. Consequently, sites at heightened risk remain exposed for longer then necessary due to the natural reluctance to discard existing costly security equipment and replace it, so as to allow protection against the new threat.

Furthermore, nowadays, any type of information is instantly accessible via Internet based search engines and anybody can make themselves more familiar with suitable attack methods in order to try and gain access into secured premises and sites under risk may be forced to constantly improve and/or replace their security systems.

BRE Group, for example, provides correct specifications of approved security systems and products, which are put under rigorous testing programmes (LPCB approved) that evaluate their ability to both resist deliberate attacks and to operate reliably throughout their service lives. The so called Loss Prevention Standard LPS 1175 is one of the key security standards used for forced entry testing. The LPS 1175 test stipulates the allowable toolset and minimum time at each security rating level to prevent forcible entry through a building element (e.g. door, window etc.). The current security ratings are:

SR1: Opportunist attack by bodily force using minimal tools (e.g. screwdriver, knife, pliers etc.). Maximum work time: 1 minute; maximum test duration: 10 min

SR2: More determined opportunist attack with tools of a higher mechanical advantage (e.g. SR1 tools plus bolt cutters, claw hammer, drill etc.). Maximum work time: 3 minute; maximum test duration: 15 min

SR3: Deliberate forced entry of protected premises using bodily force and a selection of attack options (e.g. SR2 tools plus short axe, chisel, crowbar, gas torch etc.). Maximum work time: 5 minute; maximum test duration: 20 min

SR4: Experienced attempts at forced entry with higher tool levels (e.g. SR3 tools plus felling axe, sledgehammer, steel wedges, disc grinder, jigsaw etc.). Maximum work time: 10 minute; maximum test duration: 30 min

SR5: Serious attempt at forced entry with top end battery powered tools used by fire and rescue teams (e.g. SR4 tools plus circular saw, reciprocating saw), i.e. using state of the art cutting tools. Maximum work time: 10 minute; maximum test duration: 30 min

In order to achieve a higher security rating, it is very common to simply replace the existing design with the same design but using thicker and more “exotic” materials, though, those “high-end” products are usually much more expensive than the replaced “lower-end” product.

Security doors and/or other closures may be used to secure a secured space and/or house a secured structure. It may frequently be desirable to provide air flow apertures within such a doors and/or other closure to provide a means of allowing air spaces either side of the aperture to intermix. Such apertures may include a louvre system, for example comprising a serial array of partial closures, for example disposed horizontally, which are so disposed over an opening as to tend to admit air and/or light, but to keep out for example rain, direct sunshine, and noise and/or to restrict access through the opening. The design of a louvre is in particular such as to provide a means of allowing air spaces either side of the opening to intermix providing heating or cooling effects as required usually by means of natural air circulation through the louvre.

Security louvres may be provided as part of a security system, for example in association with an opening in a secured housing for secured structure and/or in association with a security door for restricting access to a secured space for example to allow air spaces either side of the opening to intermix as above without compromising the security of the secured structure and/or secured space. Such security louvres are subject to the security considerations and standards considered above, and can represent a potential weak point in any security system.

In order to achieve a higher security rating, it is very common to simply replace the existing design with the same design but using thicker and more “exotic” materials, though, those “high-end” products are usually much more expensive than the replaced “lower-end” product.

For example, to effect an upgrade, a louvre set might be replaced by one replaced with a set made from a thicker/stronger material. Each such security level upgrade is likely to be more expensive than the previous level and the overall cost can be considerable over the lifetime of the premises. Moreover, the underlying vulnerability of the louvre assembly design to aggressive and determined attack may still represent a potential weak point in the door or closure in which it is incorporated.

Other considerations that might be relevant for improved louvre assembly design might include more effective prevention of noise transmission between the spaces either side of the opening in which the louvre assembly is provided, and the better protection of an enclosed volume not only from external attack but from external environmental factors such as flooding, extraneous material ingress etc.

Accordingly, it is an object of the present invention to provide a louvre assembly for incorporation into a ventilation opening through a door and/or housing structure that mitigates one or more of the above disadvantages. It is a particular object of the present invention to provide a louvre assembly for incorporation into a ventilation opening through a security door and/or housing structure that offers improved security. It is a preferred further object of the invention to provide a louvre assembly for incorporation into a ventilation opening through a door and/or housing structure that offers improved reduction of noise transmission between the spaces either side of the opening in which the louvre assembly is provided, and/or better protection from external environmental factors such as flooding, extraneous material ingress etc.

### SUMMARY OF THE INVENTION

Preferred embodiment(s) of the invention seek to overcome one or more of the above disadvantages of the prior art.

According to a first embodiment of the invention there is provided a louvre assembly, comprising:
a louvre housing having a continuous louvre housing perimeter wall;
a louvre housing cavity surroundingly defined and formed by the louvre housing perimeter wall so as to have first and second laterally spaced open faces;
a louvre formation comprising a plural array of louvre slats removably mountable within the louvre housing cavity;
additionally or alternatively a baffle formation removably mountable over said first open face and comprising:
   an apertured first closure plate associatively engageable with the louvre housing to seat over said first open face;
   an unapertured baffle box back plate;
   a baffle box perimeter formation extending between and laterally spacing apart the first closure plate and the baffle box back plate and forming thereby a baffle cavity;
   the baffle box perimeter formation having at least one apertured portion communicating with the said baffle cavity.

The invention thus comprises a louvre assembly for incorporation into a through opening in a door and/or housing for example for the purpose at least of allowing air spaces either side of such doors and/or internally and externally of such housing to intermix, for example for ventilation and/or temperature control.

The invention is distinctly characterised by the provision of a louvre formation comprising a plural array of louvre slats removably mountable within the louvre housing cavity to serve when so mounted as a security upgrade.

In a preferred case the louvre formation is adapted to be removably mountable onto the louvre housing perimeter wall and the louvre housing perimeter wall is adapted to mountingly receive the louvre formation. For example the louvre housing perimeter wall comprises a louvre formation mounting system, which is for example one or more apertured portions for the removable insertion of through fixings such as bolts. Providing apertured portions for through fixings such as bolts in the louvre housing perimeter wall is most secure, as the bolt heads are not then readily accessible to be sheared off under attack.

An apertured first closure plate associatively engageable with the louvre housing may be provided to seat over said first open face. A back plate may be provided to seat over said second open face.

Additionally or alternatively the invention is distinctly characterised by the provision of a baffle formation mountable over one of the open sides of the louvre housing by means of which a distinctive air through route is provided and additional functionality potentially conferred. This is provided by the baffle box perimeter formation having at least one apertured portion communicating between the said baffle cavity and the external environment on the first side of the louvre assembly. The baffle formation may be removably mountable and thus constitute a further security upgrade when so mounted or fixedly mounted in the assembled state.

Thus, the louvre assembly is of modular construction with a removably mountable louvre formation and/or a removably mountable baffle formation providing for different configurations for security upgrade or repair purposes. This can be contrasted with prior art systems where security features are permanently incorporated for example by welding and an upgrade then requires replacement of the entire louvre assembly.

Plural interchangeable removably mountable louvre formations and/or removably mountable baffle formations may be provided rated for different levels of security. Other removably mountable security elements may be provided.

The invention thus provided for group of generically designed elements capable of being relationally located in such a way that when fixed together each particular combination can provide a variety of performance characteristics providing various levels of resistance to attack. Further, these co-existing relationships can be changed to adapt the equipment to further enhance its performance should the need arise to keep step with perceived changes of threat or environmental challenges. The interchangeable elements can be completely omitted in less demanding environments.

The system is designed so that these elements can be specified and fitted at outset or added to an installation during its working life without the existing need to discard an entire product and replace it with the entire ‘new’ suitable product. This brings significant cost reductions into play in a way that should promote more timely reaction to changing threats across an estate.

Up-gradability demands are such that the product has to allow the up-gradable features to be added in a way that is also fully compliant to the security demands in-effect at the time of deployment. The act of up-grading must involve procedures that do not detract from either the pre-existing or target levels of security being provided by the product. Conventional production techniques dictate that once the product is assembled that part of the security being provided as achieved by ensuring that the product cannot be dis-assembled. The successful offering of up-gradability with this invention has overcome this conventional limitation.

Advantageously, the first closure plate is configured to extend across the entire area of the first open face defined by the louvre housing perimeter wall and to close the same, save for the aperture(s) therein. The first closure plate may be removably or fixedly mounted into position.

Advantageously, the louvre assembly may further comprise an apertured second closure plate associatively engageable with the louvre housing to seat over said second open face. Advantageously, the second closure plate is configured to extend across the entire area of the second open face defined by the louvre housing perimeter wall and to close the same, save for the aperture(s) therein. The second closure plate may be removably or fixedly mounted into position.

The second closure plate may comprise a discrete formation or may in the alternative, where the louvre assembly is adapted for use with and incorporation into a through opening in a door and/or housing wall, may comprise an integrally formed portion of a door and/or housing wall and for example a corresponding leaf thereof.

In use the first face presents to a first environmental volume, for example on a first side of a door or wall into which the louvre assembly is incorporated. The second face presents to a second environmental volume, for example on a second side of a door or wall into which the louvre assembly is incorporated.

Air flows into the louvre housing cavity from the second side, where applicable through aperture(s) in the second closure plate, providing an air communication path with the environment on the said second side. Air flows out of the louvre housing cavity towards the first side through aperture(s) in the first closure plate, thereby flowing into the baffle cavity. Air flow directly out of the baffle cavity is prevented by the unapertured and continuous baffle box back plate and instead air is enable to flow into the environment on the first side via a less direct flow path through the at least one apertured portion of the baffle box perimeter formation.

The addition of the louvre baffle with closed back plate diverts air flow from the more direct flow path that would be possible in a conventional assembly design with simple apertured front and back plates. This provides a number of potential design and operational options and advantages.

For example the baffle provides the advantage that a less direct noise path is provided. In a typical use, equipment is housed on the baffle side. This provides the advantage that the baffle tends to reflect noise generated on the baffle side thereby tending to keep it within the volume on that side, for example within a building or housing.

For example appropriate design of the apertured portion(s) within the baffle box perimeter wall may be used to control air flow through the louvre housing. Advantageously the baffle box perimeter wall may define at least one apertured portion communicating with the said baffle cavity located towards the top of the said baffle cavity.

In a typical use with equipment housed on the baffle side, this arrangement with an apertured portion communicating with the said baffle cavity located towards the top of the said baffle cavity provides the advantage that convention effects may be exploited whereby the baffle box becomes a “convection chimney” in that internally generated heat causes up-draughts which act to draw in and circulate cooling air from the second side through the louvre assembly to the first by means of a venture effect created by the baffle.

In a typical use with equipment housed on the baffle side, this arrangement with an apertured portion communicating with the said baffle cavity located towards the top of the said baffle cavity provides the further advantage that the unapertured back plate is a more effective noise barrier than a conventional louvre. Traditional louvres have a series of slots that prevent physical access to weather and unauthorised persons but to mitigate noise transmission may then need to be filled with sound absorbent material which acts contrary to the primary cooling role. The full-face baffle box back plate of the invention inherently reflects noise back towards the source without impacting on the primary cooling role of the louvre assembly. The unapertured back plate is preferably disposed to and configured to tend to reflect incident sound back and thus in use tend to contain sound on the baffle box side of the assembly.

Further potentially, this arrangement with an apertured portion communicating with the said baffle cavity located towards the top of the said baffle cavity provides the advantage in areas susceptible to flooding that a ventilation function may be provided even when the louvre assembly is partly submerged. Water may pass into the louvre housing cavity from the second side, and into the baffle cavity, but is prevented from passing directly through to the first side by the solid baffle box back plate. Even if the water level rises, so long as it remains below the level of the aperture in the baffle cavity, the water will be contained and a ventilation function maintained.

Advantageously the baffle cavity may be divided by a baffle cavity divider positioned between the first closure plate and the baffle box back plate and extending from a base of the baffle cavity for at least a major part of the upward extent of the baffle volume and serving to fluidly isolate a first sub-volume of the baffle cavity proximal to the first closure plate and a second sub-volume of the baffle cavity proximal to the baffle back plate. This has the advantage that when the louvre assembly is partly submerged to a level below a top height of the baffle cavity divider water is contained only within the first sub-volume of the baffle cavity. The baffle cavity divider is for example a baffle cavity divider plate extending from a base of the baffle cavity for at least a major part of the height thereof. The baffle cavity divider is for example disposed between and parallel to the first closure plate and the baffle back plate

Additionally for example security advantages may accrue. In a typical use, a secure side is the baffle side. The solid back plate makes a penetrative attack more difficult. Alternative fixing arrangements may be possible. The traditional large fixings of a simple apertured face plate may be replaced by alternative fixings that are not so readily accessible by cutting through the louvres.

Advantageously, the first closure plate is configured to extend across and beyond the area of the first open face defined by the louvre housing perimeter wall, having a first closure plate perimeter portion so extending beyond. Advantageously, the first closure plate perimeter portion is provided with fixing formations to fix the first closure plate to the louvre assembly and/or to fix the louvre assembly into a through opening in a door and/or housing wall in use. This provides the advantage that the fixing formations are not accessible from within the louvre housing cavity, making direct attack more difficult. Suitable fixing formations include threaded formations for example lockable threaded formations such as security bolts.

Also advantageously, the second closure plate where present is configured to extend across and beyond the area of the second open face defined by the louvre housing perimeter wall, having a second closure plate perimeter portion so extending beyond. Advantageously, the second closure plate perimeter portion is provided with fixing formations to fix the second closure plate to the louvre assembly and/or to fix the louvre assembly into a through opening in a door and/or housing wall in use. Suitable fixing formations include threaded formations for example lockable threaded formations such as security bolts.

Each of the first and second closure plates is provided with one or more apertures to permit the flow of air. For example a closure plate is provided with a plurality of slots such as horizontal slots.

Optionally, the continuous louvre housing perimeter wall defines a square or rectangular perimeter and comprises a bottom wall, two side walls and a top wall. Each wall comprises a continuous and unapertured closure of the louvre housing volume.

Optionally, the baffle box perimeter formation defines a square or rectangular perimeter and comprises a bottom wall, two sides walls and a top. Advantageously as above described the baffle box perimeter formation comprises at least one apertured portion communicating with the said baffle cavity located towards the top of the said baffle cavity. Accordingly in this embodiment the baffle box top wall may advantageously comprises an apertured top wall or an open top in which a top wall is absent. The baffle box bottom wall and two side walls may advantageously comprise with the back plate an otherwise continuous and unapertured closure of the baffle cavity. This provides the advantage that convention effects may be exploited as above. However for other applications one or more of the baffle box bottom wall and two side walls may additionally be apertured.

The baffle box perimeter formation spaces apart the first closure plate and the baffle back plate and defines with the first closure plate and the baffle back plate a baffle box volume. The first closure plate and the baffle back plate are conveniently parallel and conveniently disposed vertically in use.

A louvre formation comprising a plural array of louvre slats is mounted within the louvre housing cavity. The louvre formation may be of any suitable design. The louvre formation may for example comprise a plurality of louvre slats mounted to be arrayed successively vertically. The louvre slats may be angled acutely away from the vertical relative to the notional plane of the second open face. A louvre slat may comprise a rectangular planar formation. The louvre slats in the plural array may be of identical shape. The louvre slats in the plural array may be angled identically. The louvre slats in the plural array may be parallel.

In a further embodiment, a louvre assembly in accordance with the first embodiment is provided fixed in a through opening in a closure such as a door and/or a wall of a building or housing for example for the purpose at least of allowing air spaces either side of such doors and/or internally and externally of such housing to intermix, for example for ventilation and/or temperature control.

According to this second embodiment of the invention there is provided a closure such as a door or wall, comprising:
a first face on a first side, a second face on a second side, and a through aperture through the first face and the second face communicating between the first side and the second side;
a louvre assembly according to the first embodiment of the invention associatively mounted to the through aperture such that the louvre housing cavity is defined within the through aperture and such that the first closure plate is fixedly mounted to the said first face of the closure.

Advantageously, an apertured second closure plate is provided associatively engageable with the louvre housing to seat over said second open face of the louvre housing.

In an alternative the second closure plate is fixedly mounted to the said second face of the closure. In an alternative the second closure plate is integrally formed with the said second face of the closure.

The closure may be a security closure such as a security wall or door. In particular the security closure may define an access side and a secured side, with the baffle positioned on the secured side.

The first face of the closure for example comprises a first leaf structure and the second face of the closure for example comprises a second leaf structure, the two leaf structures being laterally spaced. The lateral space may define a cavity for additional functional structures such as security liners.

According to a third embodiment of the invention there is provided a door, comprising a leaf frame structure, having at least a top rail member, a bottom rail member, a hinge stile member and a lock stile member;
at least one first leaf panel, mountable to a first side of said leaf frame structure;
at least one second leaf panel, mountable to a second side of said leaf frame structure, that is opposite to said first side;
a through aperture through the first leaf panel and the second leaf panel communicating between the first side and the second side;
   a louvre assembly according to the first embodiment of the invention associatively mounted to the through aperture such that the louvre housing cavity is defined within the through aperture and such that the first closure plate is fixedly mounted to the said first leaf panel.

Advantageously, an apertured second closure plate is provided associatively engageable with the louvre housing to seat over said second open face of the louvre housing.

In an alternative the second closure plate is fixedly mounted to the said second leaf panel. In an alternative the second closure plate is integrally formed with the said second leaf panel.

The door may be a security door. In particular the security door may define an access side and a secured side, with the baffle positioned on the secured side.

Advantageously, the security door includes at least one security liner positioned between the at least one first and at least one second leaf panels for example in a security liner cavity formed by said leaf frame structure, said at least one inner leaf panel and said at least one outer leaf panel.

In a particular refinement of this embodiment the at least one first leaf panel and the at least one second leaf panel are removably mountable respectively to the said first and second sides of said leaf frame structures, the leaf panels thereby define at least one first upgrade cavity, formed by said leaf frame structure, said at least one inner leaf panel and said at least one outer leaf panel, accessible via said at least one inner and/or outer leaf panel and adapted to receive and operatively affix said security liner.

In an operational advantage of this arrangement plural interchangeable liners may be provided for different levels of security.

### BRIEF DESCRIPTION OF THE DRAWINGS

Preferred embodiments of the present invention will now be described, by way of example only and not in any limitative sense, with reference to the accompanying drawings, in which:

FIG. 1 shows an example of a louvre assembly of the present invention, in orientations (a) showing the second side which may typically correspond to a front face external to a secured volume in use, and (b) showing the first side which may typically correspond to a rear face internal to a secured volume in use, and showing a baffle formation thereon;

FIG. 2 shows the louvre assembly of FIG. 1 in vertical cross-section to illustrate air flow in typical use;

FIG. 3 shows the louvre assembly of FIG. 1 in perspective view to illustrate noise abatement in typical use;

FIG. 4 shows a the louvre assembly of FIG. 1 in vertical cross-section to illustrate the ventilation function effect as the assembly becomes progressively submerged;

FIG. 5 shows a pair of doors, one of which has been modified to incorporate a front grille suitable to cover the second side of a louvre assembly of the present invention mounted in association with the door;

FIG. 6 shows an internal view of the inner leaf of the modified door of FIG. 4, in alternative (a) with a louvre assembly with baffle assembly in accordance with the principles of the invention fitted in operative association with the lower grille, and in alternative (b) with a further baffle assembly fitted in operative association with the upper grille;

FIG. 7 shows an internal view a louvre formation suitable for use in the louvre/baffle assembly of the invention, respectively showing (a) the second side which may typically correspond to a front face external to a secured volume in use, and (b) showing the first side which may typically correspond to a rear face internal to a secured volume in use, and showing a baffle formation thereon

FIG. 8 shows attachment of a louvre formation suitable for use in the louvre/baffle assembly;

FIG. 9 shows a lateral bolt arrangement illustrative of a preferred method of fixing into place of the louvre formation of FIG. 8.

### DETAILED DESCRIPTION OF THE PREFERRED EMBODIMENT(S)

The exemplary embodiment(s) of this invention will be described in relation to a Louvre assembly for security doors or secured buildings or housings. However, it should be appreciated that, in general, the characteristics of the Louvre assembly of the present invention will work equally well with any building or housing structure or door.

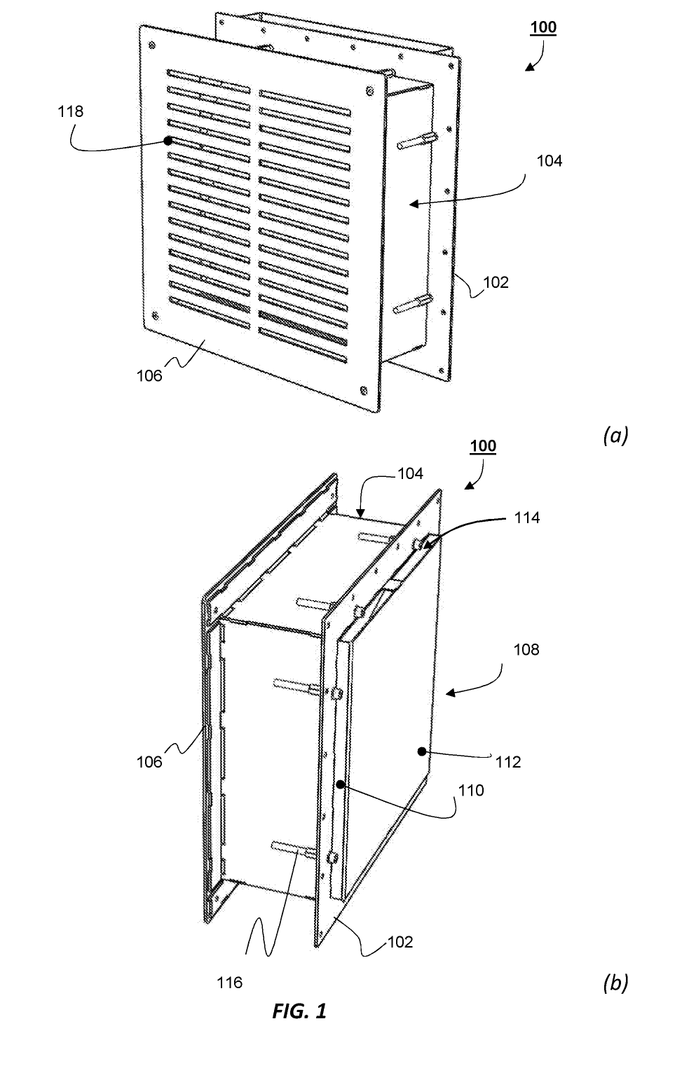

Referring now to FIG. 1, a louvre assembly 100 in accordance with the principles of the present invention is shown in an assembled configuration suitable for incorporation into a through opening in a door and/or wall of a building or housing, for example for the purpose at least of allowing air spaces either side of such a door or wall to intermix, for example for ventilation and/or temperature control.

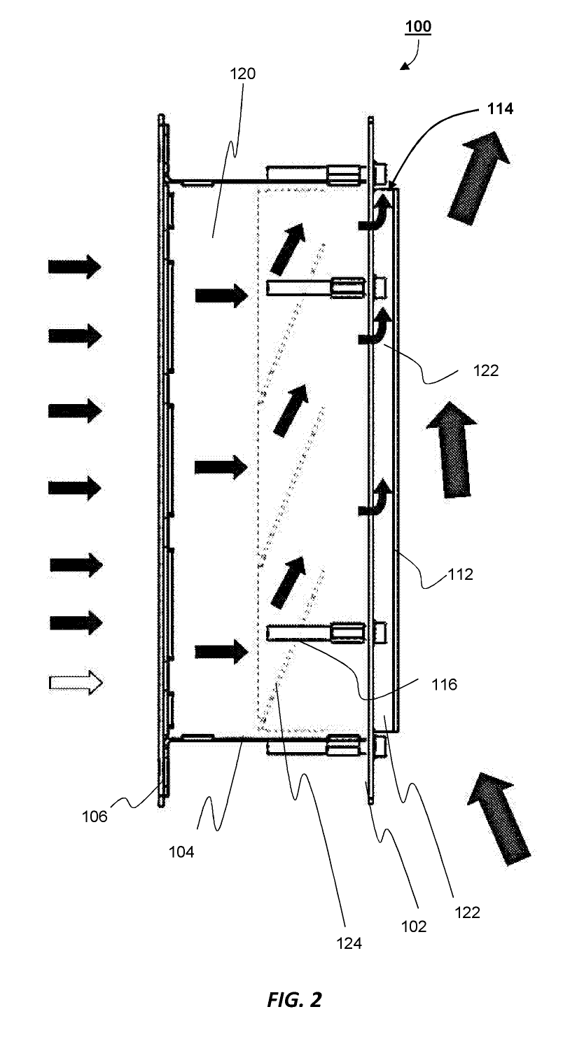

The core of the assembly is a louvre housing formed by a square louvre housing perimeter wall 104 which extends continuously around so as to surroundingly define a louvre housing cavity (see FIG. 2 for example) and is closed on a first side by the louvre housing back plate 102 and on a second side by the louvre housing face place 106. Apertures 118 in the form of slots in the louvre housing face plate 106 permit the flow of air into the louvre cavity. Apertures (not shown in FIG. 1) in the louvre housing back plate 102 permit airflow out of the louvre cavity. A baffle box 108 including an unapertured baffle box back plate 112 and a baffle box perimeter formation 110 consisting of side walls and a base extending between the baffle box back plate 112 and the louvre housing back plate 106 defines a baffle cavity (see FIG. 2). The baffle box is open at the top 114. Air may flow via the apertures in the louvre housing back plate 102 into the baffle cavity, and there is then able further to flow out of the open top 114 of the baffle volume, and thereby to flow from a first side of the louvre assembly forward of the face plate 106 to a second side of the louvre assembly rearward of the baffle box 108.

In intended use, the assembly of FIG. 1 will be positioned and fixed in a ventilation aperture in a door or wall, for example in a security door or wall, although this is not shown in the figure. Typically, the louvre housing face plate 106 may be fixedly mounted to or integrally continuous with a front leaf of such a door or wall, and the louvre housing back plate 102 may be fixed to a rear leaf of the door or wall. Screw threaded fixings 116 are provided for this purpose.

In a typical use, the louvre assembly in accordance with the invention may be incorporated as part of a security system into a security door, secure wall, wall of a secure container or the like. When so applied, the secure side, which for example represents a secured volume, a volume in which protected equipment is contained, a volume to which it is desired to limit access etc., will typically constitute the side on which the baffle is mounted. Example applications are discussed herein on that basis.

The louvre housing face plate 106 preferably sits flush with, and is for example integral with, the front leaf of such a door or wall, and in a possible embodiment the vent slots 118 can be cut from the front leaf of the door or wall. This reduces material cost as a separate face plate 106 is not in this case required. It also makes an attack by someone trying to access the area rearward of the back plate more difficult as there is no joint or fixing to attack on the front side.

The solid rear baffle box back plate 112 tends to restrict the amount of noise that can freely exit the volume beyond the baffle plate via the louvre volume. Noise escaping from the secure area, and for example from equipment contained within the secure area, is limited. The arrangement also makes any attack to gain access to the secure area significantly more difficult as a considerable amount of cutting would need to be performed to gain access through the louvre assembly, for example to high value equipment contained within the secure area. Security is further enhanced in that the screws 116 can be located outside the through volume, within the body of a security door or wall structure, for example in the cavity between a front and rear leaf thereof.

The internal volumes defined by the components illustrated in FIG. 1 are best illustrated in FIG. 2, which shows the louvre assembly of FIG. 1 in vertical cross-section, and additionally illustrates the airflow pattern during a typical use.

As can be seen in FIG. 2, the louvre housing face plate 106, louvre housing perimeter wall 104, and louvre housing back plate 102 together define and substantially enclose a louvre housing cavity 120. The louvre housing cavity contains a louvre formation having a plurality (three are illustrated) of identical parallel angled slats 124 each of which is directed at an acute angle to the vertical away from the direction of the face. A second, baffle box cavity 122 is defined between the back closure plate 102 and the baffle back plate 112. Apertures in the louvre housing face plate 106 allow air to pass from a first side (leftmost in the drawings) into the louvre housing cavity 120. Apertures in the louvre housing back plate 102 permit air to flow from the louvre housing cavity 120 into the baffle cavity 122. The open top 114 of the baffle cavity permits air to flow into the area to the right of the assembly.

A particular application of the invention is in the provision of a louvre assembly in a door or wall for ventilation of an enclosed space to equalise temperature therein. The enclosed space may be hotter than ambient, for example as a result of heat generating equipment contained within the enclosed space. FIG. 2 illustrates how the design of louvre assembly can function as a convection chimney through a venturi effect. As the temperature rises inside the equipment area convection currents are formed which will draw cooler air out of the top of the louvre baffle. As an air current builds up, more cool air is drawn into the equipment area creating a self perpetuating and self regulating air flow.

A particular application of the invention is in the provision of a louvre assembly in a door or wall of a contained volume for noise containment. A major problem for example for utility sites such as electricity substations, gas and water facilities, is that by virtue of what they do to fulfil their role in the distribution of these utility commodities they often have to be located near to housing areas. The operation of the substation or other facility can generate noise pollution in the form of pump noise or transformer hum. Traditional louvres operate by having a series of slots that simply prevent physical access to weather and unauthorised persons whereas to prevent noise escaping the louvres have to be filled with sound absorbent material which to all intents and purposes destroys the ability to source cooling air or to allow hot air to escape. The full-face baffle box back plate of the invention inherently reflects the vast majority of the noise pollution back towards the source and only very small amount of noise can escape through the louvre and the louvre still operates without the need for the additional sound absorbing material which traditionally impacts so much on the ability of the louvre from performing its primary role of cooling.

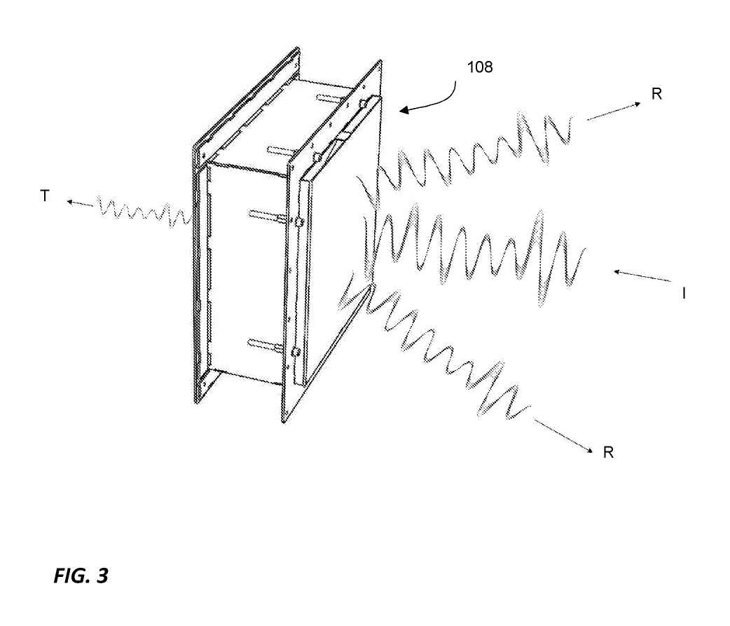

This is illustrated in FIG. 3. When noise from within the enclosure is incident (I) upon the surface of the unapertured baffle box back plate 112 of the baffle box 108 the majority of the noise would simply be reflected (R) back into the enclosure thereby reducing the levels of noise that can be transmitted (T) through the louvre assembly escape from the enclosure.

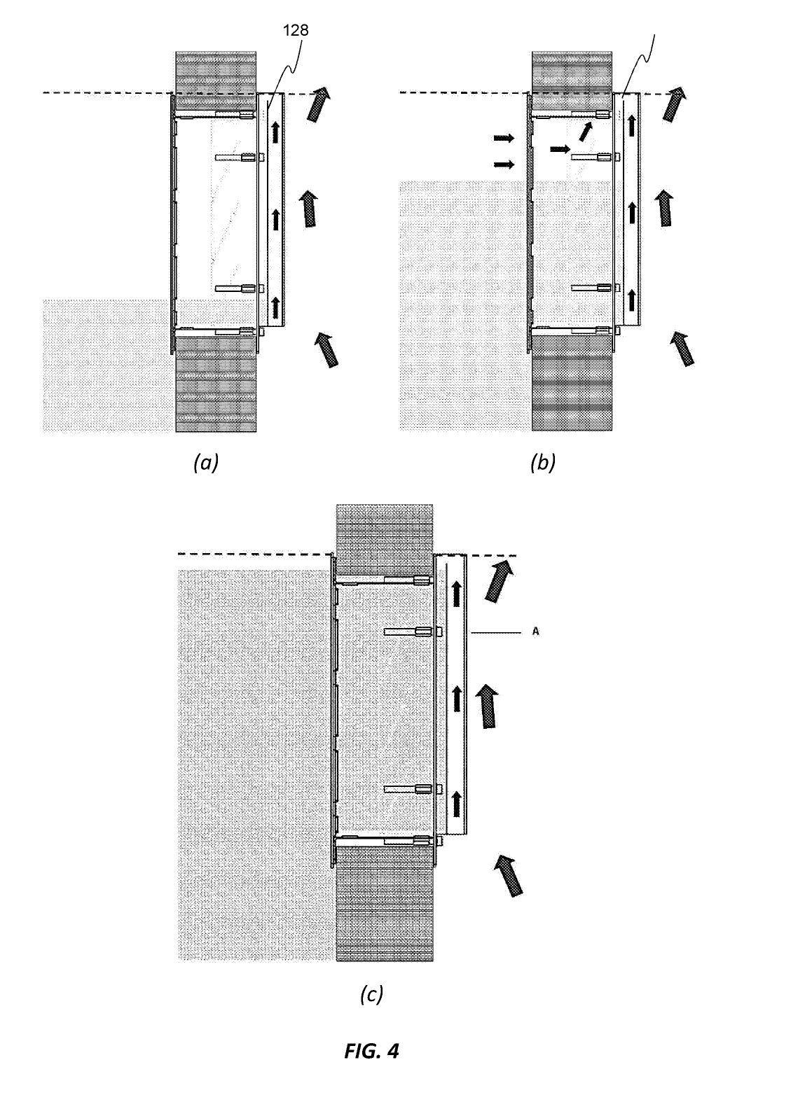

A further optional refinement of the design is illustrated in FIG. 4, in which the louvre assembly is modified to provide for a degree of flood resistance as the area around the assembly becomes progressively submerged. In the particular embodiment, a baffle box cavity divider plate 128 is provided extending substantially the full height of the baffle box so as to separate the baffle box cavity into two sub-volumes, one adjacent to the louvre housing back plate, and one adjacent to the baffle back plate. The effect of progressively rising water levels is then illustrated respectively in figures (a) to (c). It can be seen that as the water level rises, water flows into the louvre housing cavity, but even where the water has risen to relatively high levels, such as illustrated in FIG. 4(b), a flow of air from outside is still enabled, allowing the area to the right of the louvre assembly in the figure to receive the necessary ventilation until the time when the louvre is fully submerged as illustrated in FIG. 4(c). The additional venturi formed on the inside face of the louvre acts like a snorkel, and so long as air can enter the louvre housing cavity it will flow into the space to the right of the louvre assembly. The rising water level is contained within the louvre housing cavity, and although airflow will be restricted the arrangement will not allow flood water to enter the equipment room. There will still be a cooling effect as the internal convection currents pass through the venturi and are cooled by the cold surface of the internal baffle. The integrity of the building can at the same time be maintained until the water level reaches the broken line illustrated. In a further refinement, the water level that can be withstood can be set to any desired higher level by extending the height of the baffle back cover plate.

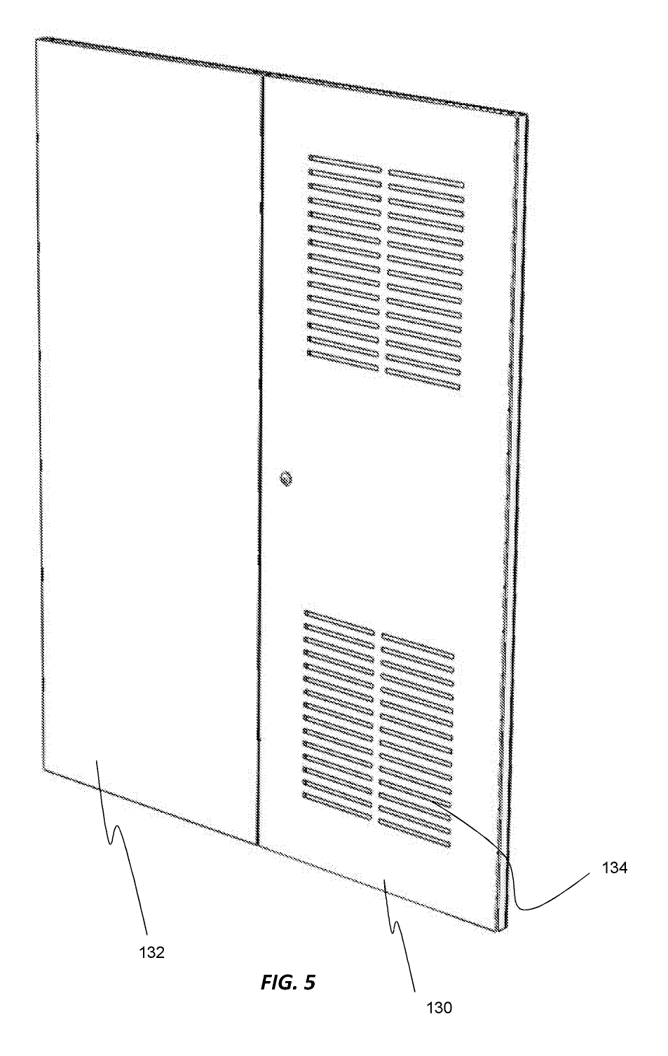

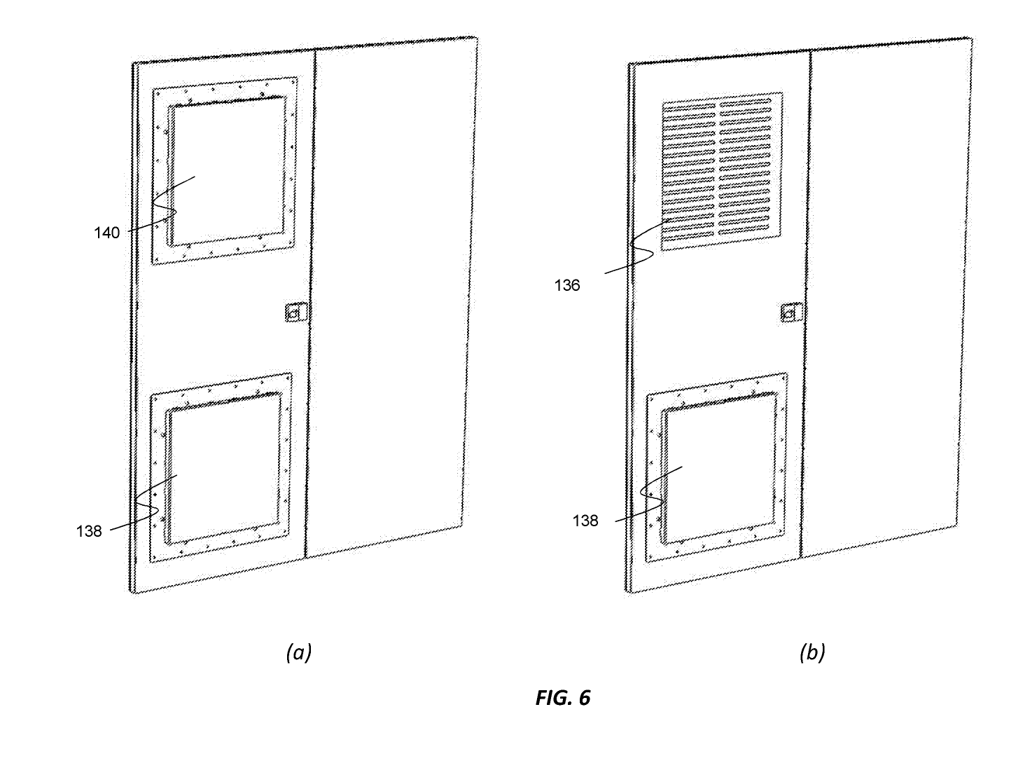

FIG. 5 shows a pair of doors 130, 132, the first of which has been modified to incorporate a front grille 134, as part of its front leaf, which is suitable to serve as a front face cover of louvre assembly of the present invention mounted in association with the door. Two alternative rear arrangements of this door are shown in FIG. 6. In FIG. 6(b) an internal view is shown of the inner leaf of the door with a bottom baffle assembly 138 in accordance with the principles of the invention fixed onto it. The resultant louvre assembly will function in the manner above described. In FIG. 6(b), a rear side 136 of the top grill is shown open. In FIG. 6(a), an internal view is shown of the inner leaf with baffle assemblies fitted to both the upper and lower grill areas. In practice it may be possible to fit only one louvre in a door using this method, but additional noise containment is nonetheless provided by the solid inner baffle assembly at both sites.

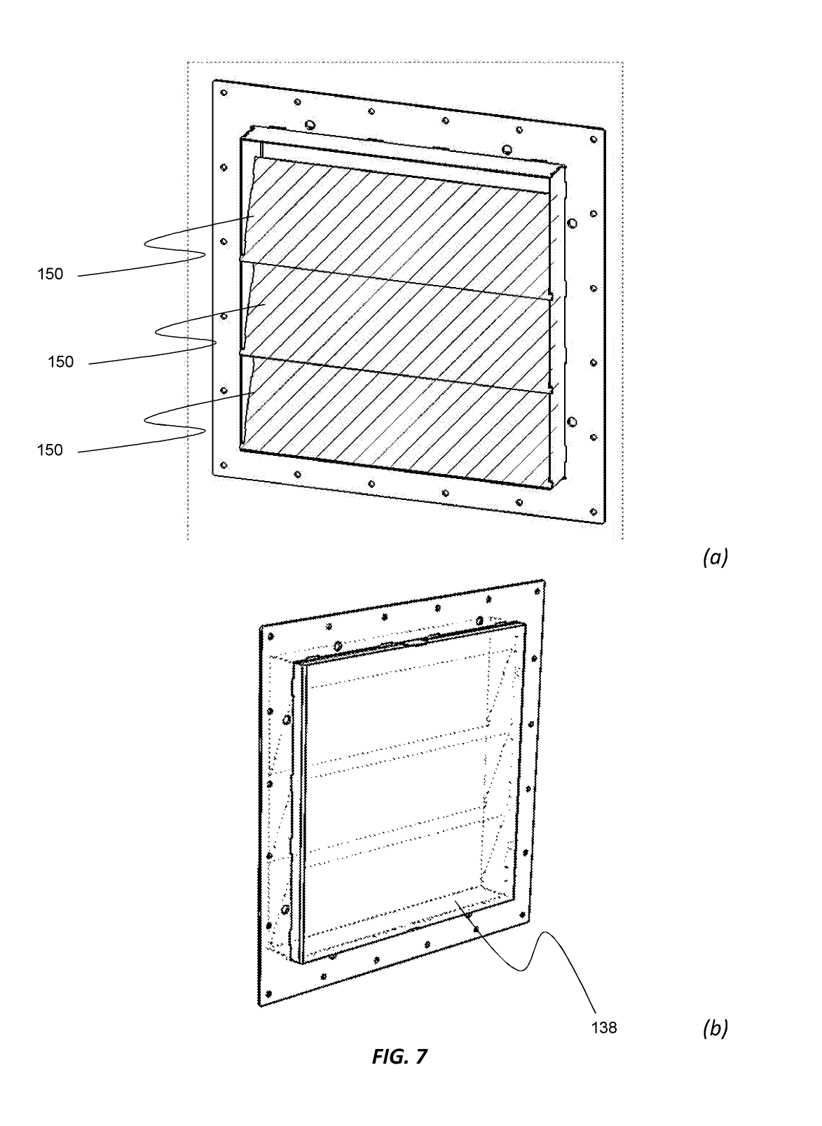

FIG. 7 shows the louvre arrangement in more detail, with some of the louvre housing covers removed. As shown in FIG. 7(a), three angled louvre slats 150 provide environmental sealing against rain ingress as any water will tend to fall and be guided out of the enclosure by the slats. FIG. 7(b) shows a rear view of the same arrangement with the baffle assembly in place, but with the position of three angled slats shown with dotted lines. This is the visible face of the assembly as would be seen from inside an enclosed/secured volume. The assembly is bolted to the enclosure using the mounting holes provided. The solid flat internal face of the baffle may be made to varying thicknesses depending on the degree of noise protection and/or degree of security and attack resistance required.

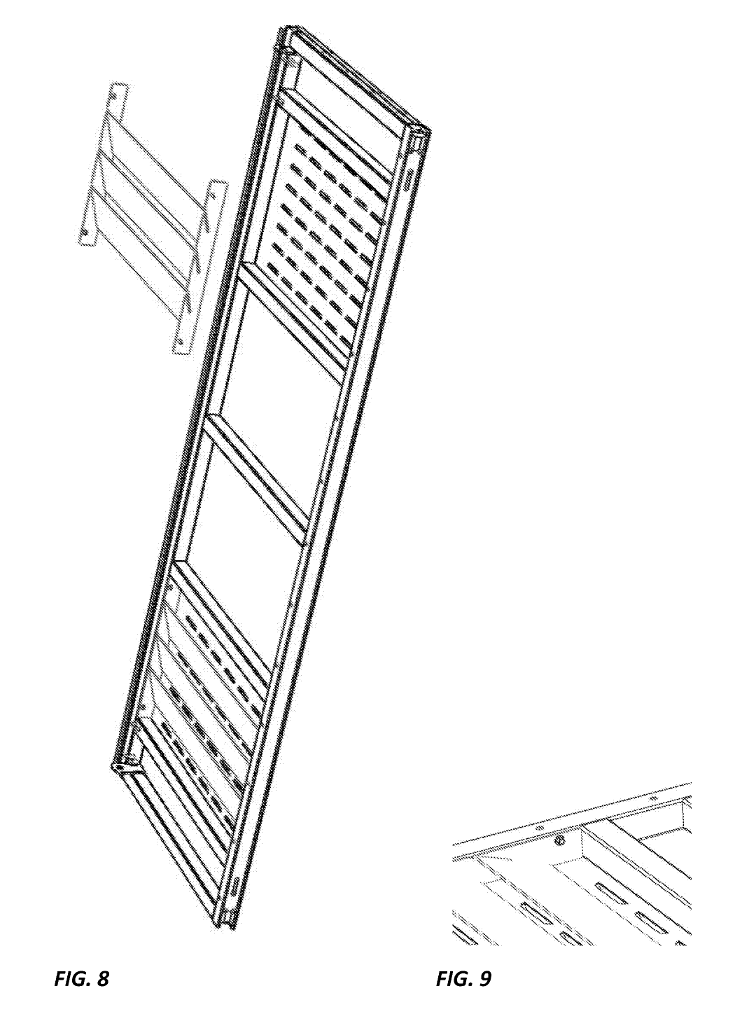

FIG. 8 shows attachment of a louvre formation suitable for use in the louvre/baffle assembly via lateral fixings (in the embodiments bolts) into receiving apertures in the perimeter wall of the louvre cavity. The attachment system of this embodiment is shown in more detail in FIG. 9. This location and orientation of bolts is preferred as it is less accessible and harder to shear the bolts off.

Attachment of the louvre formation can be done for security upgrade or repair purposes. Interchangeable louvre formations with alternative structures and for example alternative security ratings may be provided.

It will be appreciated by persons skilled in the art that the above embodiment(s) has been described by way of example only and not in any limitative sense, and that various alterations and modifications are possible without departing from the scope of the invention as defined by the appended claims.

1. A louvre assembly comprising:
a louvre housing having a continuous louvre housing perimeter wall;
a louvre housing cavity surroundingly defined and formed by the louvre housing perimeter wall so as to have first and second laterally spaced open faces;
a louvre formation comprising a plural array of louvre slats removably mountable within the louvre housing cavity; and
wherein the louvre housing perimeter wall is adapted to mountingly receive the removably mountable louvre formation.

2. The louvre assembly according to claim 1, wherein the louvre housing perimeter wall comprises a louvre formation mounting system.

3. The louvre assembly according to claim 2, wherein the louvre formation mounting system comprises one or more apertured portions for the removable insertion of through fixings.

4. The louvre assembly according to claim 1, further comprising an apertured first closure plate associatively engageable with the louvre housing to seat over the first open face.

5. The louvre assembly according to claim 4, wherein the first closure plate is configured to extend across the entire area of the first open face defined by the louvre housing perimeter wall and to close the same, save for the aperture(s) therein.

6. The louvre assembly according to claim 4, further comprising an apertured second closure plate associatively engageable with the louvre housing to seat over the second open face.

7. The louvre assembly according to claim 6, wherein the second closure plate is configured to extend across the entire area of the second open face defined by the louvre housing perimeter wall and to close the same, save for the aperture(s) therein.

8. The louvre assembly according to claim 6, wherein the louvre assembly is adapted for use with and incorporation into a through opening in a door and/or housing wall, and the second closure plate comprises an integrally formed portion of the door and/or housing wall and for example a corresponding leaf thereof.

9. The louvre assembly according to claim 1, further comprising:
a baffle formation removably mountable over the second open face and comprising:
an unapertured baffle box back plate;
a baffle box perimeter formation extending between and laterally spacing apart the first closure plate and the baffle box back plate and forming thereby a baffle cavity;
the baffle box perimeter formation having at least one apertured portion communicating with the said baffle cavity.

10. The louvre assembly according to claim 9, wherein the baffle box perimeter wall defines at least one apertured portion communicating with the baffle cavity located towards the top of the said baffle cavity.

11. The louvre assembly according to claim 9, wherein the baffle cavity is divided by a baffle cavity divider positioned between the first closure plate and the baffle box back plate, extending from a base of the baffle cavity for at least a major part of an upward extent of the baffle cavity and serving to fluidly isolate a first sub-volume of the baffle cavity proximal to the first closure plate and a second sub-volume of the baffle cavity proximal to the baffle back plate.

12. The louvre assembly according to claim 9, wherein the baffle box perimeter formation defines a square or rectangular perimeter and comprises a bottom wall, two side walls and a top.

13. The louvre assembly according to claim 12, wherein the top comprises an apertured top wall or an open top in which a top wall is absent.

14. The louvre assembly according to claim 9, wherein the baffle box perimeter formation spaces apart the first closure plate and the baffle back plate such that the first closure plate and the baffle back plate are conveniently parallel and disposed vertically.

15. The louvre assembly according to claim 1, comprising an apertured first closure plate configured to extend across and beyond the area of the first open face defined by the louvre housing perimeter wall, having a first closure plate perimeter portion so extending beyond.

16. The louvre assembly according to claim 15, wherein the first closure plate perimeter portion is provided with fixing formations to perform at least one of the following:
fix the first closure plate to the louvre assembly;
fix the louvre assembly into a through opening in a door in use; and
fix the louvre assembly into a through opening in a housing wall in use.

17. The louvre assembly according to claim 1, comprising an apertured second closure plate associatively engageable with the louvre housing to seat over the second open face wherein the second closure plate is configured to extend across and beyond the area of the second open face defined by the louvre housing perimeter wall, having a second closure plate perimeter portion so extending beyond.

18. The louvre assembly according to claim 1, wherein the continuous louvre housing perimeter wall defines a square or rectangular perimeter and comprises a bottom wall, two side walls and a top wall, each wall comprising a continuous and unapertured closure.

19. The louvre assembly according to claim 1, wherein the louvre formation comprises a plural array of louvre slats mounted within the louvre housing cavity to be arrayed successively vertically in parallel orientation such that each slat is angled acutely away from the vertical relative to the notional plane of the second open face.

20. The louvre assembly according to claim 1, provided fixed in a through opening in a closure such as a door and/or a wall of a building or housing.

21. A closure such as a door or wall, the closure comprising:
a first face on a first side, a second face on a second side, and a through aperture through the first face and the second face communicating between the first side and the second side; and
a louvre assembly according to claim 1 associatively mounted to the through aperture such that the louvre housing cavity is defined within the through aperture and such that the first closure plate is fixedly mounted to the first face of the closure.

22. The closure according to claim 21, wherein an apertured second closure plate is provided associatively engageable with the louvre housing to seat over the second open face of the louvre housing.

23. The closure according to claim 22, wherein the second closure plate is a discrete formation fixedly mounted to the said second face of the closure.

24. The closure according to claim 22, wherein the second closure plate is integrally formed with the second face of the closure.

25. The closure according to claim 17, wherein the closure is a security closure defining an access side and a secured side, with the baffle positioned on the secured side.

26. A door comprising:
a leaf frame structure, having at least a top rail member, a bottom rail member, a hinge stile member and a lock stile member;
at least one first leaf panel, mountable to a first side of the leaf frame structure;
at least one second leaf panel, mountable to a second side of the leaf frame structure, that is opposite to the first side;
a through aperture through the first leaf panel and the second leaf panel communicating between the first side and the second side; and
a louvre assembly according to claim 1 associatively mounted to the through aperture such that the louvre housing cavity is defined within the through aperture and such that the first closure plate is fixedly mounted to the first leaf panel.
